(19) United States
(12) Patent Application Publication
(10) Pub. No.: US 2025/0349070 A1
(43) Pub. Date: Nov. 13, 2025

(54) VIRTUAL ASSISTANT INTERACTIONS IN A 3D ENVIRONMENT

(71) Applicant: Apple Inc., Cupertino, CA (US)

(72) Inventors: Divine Keetle-Maloney, Santa Clara, CA (US); Dong Joo Byun, Burbank, CA (US); Saschka Unseld, San Francisco, CA (US); David Hobbins, Venice, CA (US); Jaehyun Kim, San Francisco, CA (US); Jose Moises Tafolla Carmona, San Jose, CA (US); Derek A. Hunter, Aptos, CA (US); Yaniv Gur, Los Altos, CA (US)

(21) Appl. No.: 19/179,613

(22) Filed: Apr. 15, 2025

Related U.S. Application Data
(60) Provisional application No. 63/644,809, filed on May 9, 2024.

(51) Int. Cl. G06T 17/00; G06F 3/01; G06F 3/04815

(52) U.S. Cl. CPC G06T 17/00; G06F 3/013; G06F 3/04815

(57) ABSTRACT

Devices, systems, and methods that present a virtual assistant that provides natural assistant interactions in an extended reality (XR) environment. For example, an example process may include presenting a view of a three-dimensional (3D) environment with a virtual assistant. The process may further include receiving data corresponding to first user activity in the 3D coordinate system and identifying a user interaction event associated with the virtual assistant based on the data corresponding to the user activity. The process may further include providing a graphical indication corresponding to one or more attributes associated with the virtual assistant based on identifying the user interaction event. The process may further include generating one or more user interface elements that are positioned at 3D positions based on the 3D coordinate system associated with the 3D environment in accordance with receiving data corresponding to a second user activity.

### CROSS-REFERENCE TO RELATED APPLICATIONS

This Application claims the benefit of U.S. Provisional Application Ser. No. 63/644,809 filed May 9, 2024, which is incorporated herein in its entirety.

### TECHNICAL FIELD

The present disclosure generally relates to systems, methods, and devices that enable assessing user interactions to control a virtual assistant of a user interface of an electronic device.

### BACKGROUND

It may be desirable to detect movement and interactions associated with a virtual assistant of a user interface while a user is using a device, such as a head mounted device (HMD). However, existing systems may not provide adequate activation and display of the virtual assistant that provide natural interactions based on user attention and when a user is interacting with the user interface within a user's space (e.g., a view of a three-dimensional (3D) environment, such as an extended reality view).

### SUMMARY

Various implementations disclosed herein include devices, systems, and methods that present a real-time intelligent virtual assistant that provides natural assistant interactions using a large language model (LLM) in an extended reality (XR) environment. In some embodiments, the intelligent virtual assistant may be embodied as an artificial intelligence (AI) tutor within a user's space (e.g., a view of a three-dimensional (3D) environment, such as an extended reality view). The intelligent virtual assistant may be triggered (e.g., activated) by gaze, voice activation (e.g., via a trigger phrase such as “Hey Assistant”), or by other detection of user interactions (e.g., hand-based interaction data).

In some embodiments, the intelligent virtual assistant may generate multiple Al user interface elements based on the user input to customize the experience. For example, a user may initiate an interaction by stating, e.g., “show me clouds”, and the intelligent virtual assistant may generate a two-dimensional (2D) webpage for general knowledge based information of clouds, an additional webpage (widget) for video/images of different clouds, a 3D interactive model of one or more clouds, and/or change the entire theme of a current view of the room/experience (e.g., display a ceiling of virtual clouds).

In some embodiments, the intelligent virtual assistant may direct a user's attention to a learning objective (e.g., a single endpoint), guide a user with multiple endpoints for a step-by-step process, and/or manipulate the 3D environment by moving endpoints or virtual objects. In some embodiments, the intelligent virtual assistant may be personalized to each user and adjusted based on physiological cues of the user, or teaching methods that pertain to the user (e.g., learning math as a fourth grader compared to a college student). In some embodiments, one or more attributes of the intelligent virtual assistant may be adjusted based on context (e.g., happy vs sad eyes, facial expressions, body language, voice tone, etc.).

User privacy may be preserved by only providing some user activity information to the separately-executed apps, e.g., withholding user activity information that is not associated with intentional user actions such as user actions that are intended by the user to provide input or certain types of input. In one example, raw hands data, gaze data, and/or voice/audio data may be excluded from the data provided to the applications such that applications receive limited or no information about what the user is saying or pointing at, where the user is looking, or what the user is looking at times when there is no intentional user interface interaction.

In general, one innovative aspect of the subject matter described in this specification can be embodied in methods, at an electronic device having a processor, a display, and one or more sensors, that include the actions of presenting a view of a three-dimensional (3D) environment, wherein a virtual assistant is positioned at a 3D position based on a 3D coordinate system associated with the 3D environment. The action may further include receiving data corresponding to a first user activity in the 3D coordinate system for a first period of time. The action may further include identifying a user interaction event associated with the virtual assistant in the 3D environment based on the data corresponding to the user activity. The action may further include providing a graphical indication corresponding to one or more attributes associated with the virtual assistant based on identifying the user interaction event. The action may further include in accordance with receiving data corresponding to a second user activity for a second period of time, generating one or more user interface elements that are positioned at 3D positions based on the 3D coordinate system associated with the 3D environment.

These and other embodiments may each optionally include one or more of the following features.

In some aspects, the one or more user interface elements are customized based on a large language model (LLM) associated with the virtual assistant. In some aspects, the one or more attributes associated with the virtual assistant are based on adjustable settings that includes at least one of a type of large language model (LLM), a type of personality, a response style, a temperature style, and a pedagogical approach selection.

In some aspects, generating the one or more user interface elements includes determining one or more candidate representations based on a determined context of the one or more utterances. In some aspects, the one or more candidate representations are updated based on data corresponding to user activity for a second period of time. In some aspects, the one or more candidate representations includes at least one of a candidate text representation, a candidate audio representation, a candidate image representation, a candidate video representation, and a candidate virtual object representation.

In some aspects, the candidate virtual object representation includes a 3D interactive model. In some aspects, the method further includes the actions of providing a stream of spatialized audio at a 3D position within the 3D coordinate system associated with the 3D environment, wherein the 3D position of the stream of spatialized audio corresponds to the 3D position of the virtual assistant. In some aspects, utterances associated with the stream of spatialized audio are correlated to utterances associated with the candidate text representation. In some aspects, utterances associated with the stream of spatialized audio are different than the candidate text representation.

In some aspects, the graphical indication is a virtual effect corresponding to an eye or pair of eyes associated with the virtual assistant. In some aspects, the method further includes the actions of determining a context of a user based on at least one of the first user activity, the second user activity, and one or more physiological cues of the user, and updating the graphical indication of the virtual assistant is based on the determined context.

In some aspects, the data corresponding to the first user activity or the data corresponding to the second user activity is obtained via the one or more sensors on the device. In some aspects, the data corresponding to the first user activity or the data corresponding to the second user activity includes gaze data including a stream of gaze vectors corresponding to gaze directions over time during use of the electronic device.

In some aspects, the data corresponding to the first user activity or the data corresponding to the second user activity includes an audio stream that includes one or more utterances. In some aspects, the data corresponding to the first user activity or the data corresponding to the second user activity includes instructions received via an input device.

In some aspects, the data corresponding to the first user activity or the data corresponding to the second user activity includes hands data that includes a hand pose skeleton of multiple joints for each of multiple instants in time during use of the electronic device. In some aspects, the data corresponding to the first user activity or the data corresponding to the second user activity includes at least one of hands data, controller data, gaze data, and head movement data.

In some aspects, the electronic device includes a head-mounted device (HMD).

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1B illustrate exemplary electronic devices operating in a physical environment in accordance with some implementations.

FIG. 2 illustrates views, provided via a device, of user interface elements and a virtual assistant within the 3D physical environment of FIGS. 1A-1B in which the user performs interactions in accordance with some implementations.

FIG. 3 illustrates a view, provided via a device, of user interface elements and a virtual assistant within the 3D physical environment of FIGS. 1A-1B in which the user performs an interaction in accordance with some implementations.

FIG. 4 illustrates an example of tracking user activity data during a user interaction with a virtual assistant, in accordance with some implementations.

FIGS. 5A and 5B illustrate views of an example of user activity and interaction recognition with a virtual assistant, and generating a user interface element in response, in accordance with some implementations.

FIGS. 6A and 6B illustrate views of an example of user activity and interaction recognition with a virtual assistant, and generating a user interface element in response, in accordance with some implementations.

FIGS. 7A and 7B illustrate views of an example of user activity and interaction recognition with a virtual assistant, and generating a user interface element in response, in accordance with some implementations.

FIG. 8 illustrates use of an exemplary input support framework to generate interaction data based on hands data, gaze data, audio data, and user interface target data, in accordance with some implementations.

FIG. 9 illustrates an example of interaction recognition of user activity with a virtual assistant and generating one or more user interface elements in response, in accordance with some implementations.

FIG. 10 is a flowchart illustrating a method for generating one or more user interface elements based on identifying a user interaction event corresponding to the user activity with a virtual assistant, in accordance with some implementations.

FIG. 11 is a block diagram of an electronic device of in accordance with some implementations.

FIG. 12 is a block diagram of an exemplary head-mounted device, in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

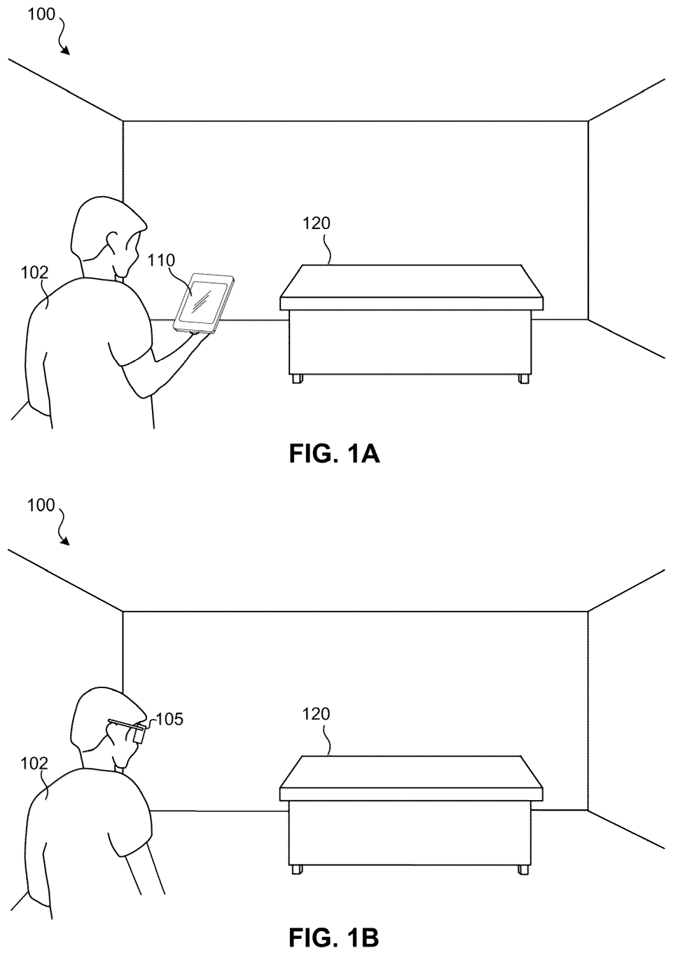

FIGS. 1A-1B illustrate exemplary electronic devices 105 and 110 operating in a physical environment 100. In the example of FIGS. 1A-1B, the physical environment 100 is a room that includes a desk 120. The electronic devices 105 and 110 may include one or more cameras, microphones, depth sensors, or other sensors that can be used to capture information about and evaluate the physical environment 100 and the objects within it, as well as information about the user 102 of electronic devices 105 and 110. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown) via electronic devices 105 (e.g., a wearable device such as an HMD) and/or 110 (e.g., a handheld device such as a mobile device, a tablet computing device, a laptop computer, etc.). Such an XR environment may include views of a 3D environment seen through a transparent or translucent display or a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system (e.g., a 3D space) associated with the XR environment, which may correspond to a 3D coordinate system of the physical environment 100.

In some implementations, video (e.g., pass-through video depicting a physical environment) is received from an image sensor of a device (e.g., device 105 or device 110). In some implementations, a 3D representation of a virtual environment is aligned with a 3D coordinate system of the physical environment. A sizing of the 3D representation of the virtual environment may be generated based on, inter alia, a scale of the physical environment or a positioning of an open space, floor, wall, etc. such that the 3D representation is configured to align with corresponding features of the physical environment. In some implementations, a viewpoint within the 3D coordinate system may be determined based on a position of the electronic device within the physical environment. The viewpoint may be determined based on, inter alia, image data, depth sensor data, motion sensor data, etc., which may be retrieved via a virtual inertial odometry system (VIO), a simultaneous localization and mapping (SLAM) system, etc.

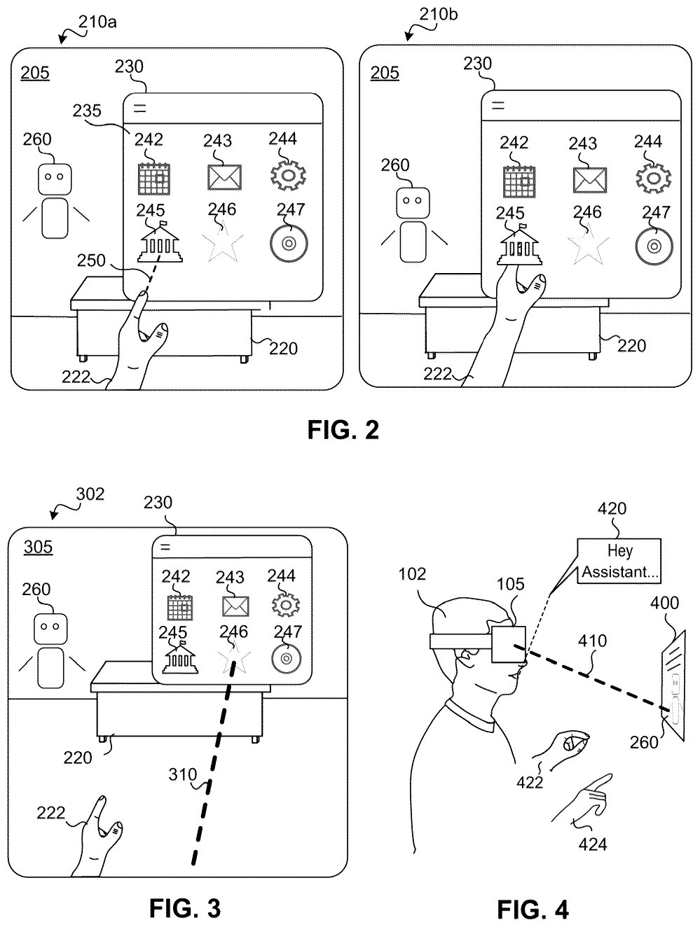

FIG. 2 illustrates views, provided via a device, of user interface elements within the 3D physical environment of FIGS. 1A-1B, in which the user performs an interaction (e.g., a direct interaction). In this example, the user 102 makes a hand gesture relative to content presented in views 210a-b of an XR environment provided by a device (e.g., device 105 or device 110). The views 210a-b of the XR environment include an exemplary user interface 230 of an application (e.g., an example of virtual content) and a representation 220 of the desk 120 (e.g., an example of real content). Providing such a view may involve determining 3D attributes of the physical environment 100 and positioning the virtual content, e.g., user interface 230, in a 3D coordinate system corresponding to that physical environment 100.

In the example of FIG. 2, the user interface 230 includes various content user interface elements, including a background portion 235 and user interface elements 242, 243, 244, 245, 246, 247. The user interface elements 242, 243, 244, 245, 246, 247 may be displayed on the flat two-dimensional (2D) user interface 230. The user interface 230 may be a user interface of an application, as illustrated in this example. In some implementations, an indicator (e.g., a pointer, a highlight structure, etc.) may be used for indicating a point of interaction with any of user interface (visual) elements (e.g., if using a controller device, such as a mouse or other input device). The user interface 230 is simplified for purposes of illustration and user interfaces in practice may include any degree of complexity, any number of content items, and/or combinations of 2D and/or 3D content. The user interface 230 may be provided by operating systems and/or applications of various types including, but not limited to, messaging applications, web browser applications, content viewing applications, content creation and editing applications, or any other applications that can display, present, or otherwise use visual and/or audio content.

In this example, the background portion 235 of the user interface 230 is flat. In this example, the background portion 235 includes all aspects of the user interface 230 being displayed except for the user interface elements 242, 243, 244, 245, 246, 247. Displaying a background portion of a user interface of an operating system or application as a flat surface may provide various advantages. Doing so may provide an easy to understand or otherwise use portion of an XR environment for accessing the user interface of the application. In some implementations, multiple user interfaces (e.g., corresponding to multiple, different applications) are presented sequentially and/or simultaneously within an XR environment, e.g., within one or more colliders or other such components.

Additionally, the XR environment 205 includes a virtual assistant 260. The virtual assistant 260 illustrates a real-time intelligent virtual assistant that provides natural assistant interactions using a large language model (LLM) in an XR environment. The virtual assistant 260 may be embodied as an artificial intelligence (AI) tutor within the view of a 3D environment (e.g., an XR environment). The virtual assistant 260 is illustrated as a virtual robot, but the virtual assistant 260 may be embodied in other forms (e.g., more human like, an animal, a cartoon figure, etc.). The virtual assistant 260 may be triggered (e.g., activated) based on detecting gaze data, audio data (e.g., a voice activation trigger, such as “Hey Assistant”), or by other detection of user interactions (e.g., hand-based interaction data), as further discussed herein. In an exemplary embodiment, for the context of determining user interactions based on user activity data (e.g., gaze, voice, hands, etc.) the virtual assistant 260 may also be referred to as a user interface.

In some implementations, the positions and/or orientations of such one or more user interfaces, including the virtual assistant 260, may be determined to facilitate visibility and/or use. The one or more user interfaces, including the virtual assistant 260, may be at fixed positions and orientations within the 3D environment. In such cases, user movements would not affect the position or orientation of the user interfaces within the 3D environment.

The position of the user interfaces (e.g., user interface 230, virtual assistant 260, etc.) within the 3D environment may be based on determining a distance of the user interface from the user (e.g., from an initial or current user position). The position and/or distance from the user may be determined based on various criteria including, but not limited to, criteria that accounts for application type, application functionality, content type, content/text size, environment type, environment size, environment complexity, environment lighting, presence of others in the environment, use of the application or content by multiple users, user preferences, user input, and numerous other factors.

In some implementations, the one or more user interfaces may be body-locked content, e.g., having a distance and orientation offset relative to a portion of the user's body (e.g., their torso). For example, the body-locked content of a user interface could be 0.5 meters away and 45 degrees to the left of the user's torso's forward-facing vector. If the user's head turns while the torso remains static, a body-locked user interface would appear to remain stationary in the 3D environment at 2 m away and 45 degrees to the left of the torso's front facing vector. However, if the user does rotate their torso (e.g., by spinning around in their chair), the body-locked user interface would follow the torso rotation and be repositioned within the 3D environment such that it is still 0.5 meters away and 45 degrees to the left of their torso's new forward-facing vector.

In other implementations, user interface content is defined at a specific distance from the user with the orientation relative to the user remaining static (e.g., if initially displayed in a cardinal direction, it will remain in that cardinal direction regardless of any head or body movement). In this example, the orientation of the body-locked content would not be referenced to any part of the user's body. In this different implementation, the body-locked user interface would not reposition itself in accordance with the torso rotation. For example, a body-locked user interface may be defined to be 2 m away and, based on the direction the user is currently facing, may be initially displayed north of the user. If the user rotates their torso 180 degrees to face south, the body-locked user interface would remain 2 m away to the north of the user, which is now directly behind the user.

A body-locked user interface could also be configured to always remain gravity or horizon aligned, such that head and/or body changes in the roll orientation would not cause the body-locked user interface to move within the 3D environment. Translational movement would cause the body-locked content to be repositioned within the 3D environment in order to maintain the distance offset.

In some implementations, when there are two or more user interfaces (e.g., user interface 230, virtual assistant 260, etc.), each user interface may be separately positioned with respect to the user or the 3D environment (e.g., body-locked or anchored to a fixed position in the 3D environment). For example, the user interface 230 may be anchored as a 2D webpage affixed at particular 3D position within the 3D environment, and/or set at some distance with respect to the representation 220 (e.g., placed above the representation of the desk 120). While the user interface 230 is locked at the particular 3D position, at the same time, the virtual assistant 260 may be body-locked, such that as a user moves his or her head, body, gaze, or position within the 3D environment, the virtual assistant 260 may move within the XR environment 205 to always appear in a similar position with respect to the user's viewpoint (e.g., centered and off to the left of the view 210a,b, as currently illustrated in FIG. 2).

In the example of FIG. 2, the user 102 moves their hand from an initial position as illustrated by the position of the representation 222 in view 210a. The hand moves along path 250 to a later position as illustrated by the position of the representation 222 in the view 210b. As the user 102 moves their hand along this path 250, the finger intersects the user interface 230. Specifically, as the finger moves along the path 250, it virtually pierces the user interface element 245 and thus a tip portion of the finger (not shown) is occluded in view 210b by the user interface 230.

Implementations disclosed herein interpret user movements such as the user 102 moving their hand/finger along path 250 relative to a user interface element such as user interface element 245 to recognize user input/interactions. The interpretation of user movements and other user activity may be based on recognizing user intention using one or more recognition processes.

Recognizing input in the example of FIG. 2 may involve determining that a gesture is a direct interaction and then using a direct input recognition process to recognize the gesture. For example, such a gesture may be interpreted as a tap input to the user interface element 245. In making such a gesture, the user's actual motion relative to the user interface element 245 may deviate from an ideal motion (e.g., a straight path through the center of the user interface element in a direction that is perfectly orthogonal to the plane of the user interface element). The actual path may be curved, jagged, or otherwise non-linear and may be at an angle rather than being orthogonal to the plane of the user interface element. The path may have attributes that make it similar to other types of input gestures (e.g., swipes, drags, flicks, etc.) For example, the non-orthogonal motion may make the gesture similar to a swipe motion in which a user provides input by piercing a user interface element and then moving in a direction along the plane of the user interface.

Some implementations disclosed herein determine that a direct interaction mode is applicable and, based on the direct interaction mode, utilize a direct interaction recognition process to distinguish or otherwise interpret user activity that corresponds to direct input, e.g., identifying intended user interactions, for example, based on if, and how, a gesture path intercepts one or more 3D regions of space. Such recognition processes may account for actual human tendencies associated with direct interactions (e.g., natural arcing that occurs during actions intended to be straight, tendency to make movements based on a shoulder or other pivot position, etc.), human perception issues (e.g., user's not seeing or knowing precisely where virtual content is relative to their hand), and/or other direct interaction-specific issues.

Note that the user's movement in the real world (e.g., physical environment 100) correspond to movements within a 3D space, e.g., an XR environment that is based on the real-world and that includes virtual content such as user interface positioned relative to real-world objects including the user. Thus, the user is moving his hand in the physical environment 100, e.g., through empty space, but that hand (e.g., a depiction or representation of the hand) intersects with and/or pierces through the user interface 300 of the XR environment that is based on that physical environment. In this way, the user virtually interacts directly with the virtual content.

FIG. 3 illustrates an exemplary view, provided via a device, of user interface elements within the 3D physical environment of FIGS. 1A-1B in which the user performs an interaction (e.g., an indirect interaction based on gaze and pointing). In this example, the user 102 makes a hand gesture while looking at content presented in the view 302 of an XR environment provided by a device (e.g., device 105 or device 110). The view 302 of the XR environment includes the exemplary user interface 230 FIG. 2. In the example of FIG. 3, the user 102 makes a pointing gesture with their hand as illustrated by the representation 222 while gazing along gaze direction 310 at user interface icon 246 (e.g., a star shaped application icon or widget). In this example, this user activity (e.g., a pointing hand gesture along with a gaze at a user interface element) corresponds to a user intention to interact with user interface icon 246, e.g., the point signifies a potential intention to interact and the gaze (at the point in time of the point) identifies the target of the interaction (e.g., waiting for the system to highlight the icon to indicate to the user of the correct target before initiating an interaction from another user activity, such as via a pinch gesture).

Implementations disclosed herein interpret user activity, such as the user 102 with a pointing hand gesture along with a gaze at a user interface element, to recognize user/interactions. For example, such user activity may be interpreted as a tap input to the user interface element 246, e.g., selecting user interface element 246. However, in performing such actions, the user's gaze direction and/or the timing between a gesture and gaze with which the user intends the gesture to be associated may be less than perfectly executed and/or timed.

Some implementations disclosed herein determine that an indirect interaction mode is applicable and, based on the indirect interaction mode, utilize an indirect interaction recognition process to identify intended user interactions based on user activity, for example, based on if, and how, a gesture path intercepts one or more 3D regions of space. Such recognition processes may account for actual human tendencies associated with indirect interactions (e.g., eye saccades, eye fixations, and other natural human gaze behavior, arching hand motion, retractions not corresponding to insertion directions as intended, etc.), human perception issues (e.g., user's not seeing or knowing precisely where virtual content is relative to their hand), and/or other indirect interaction-specific issues.

Some implementations determine an interaction mode, e.g., a direct interaction mode or indirect interaction mode, so that user behavior can be interpreted by a specialized (or otherwise separate) recognition process for the appropriate interaction type, e.g., using a direct interaction recognition process for direct interactions and an indirect interaction recognition process or indirect interactions. Such specialized (or otherwise separate) process utilization may be more efficient, more accurate, or provide other benefits relative to using a single recognition process configured to recognize multiple types (e.g., both direct and indirect) interactions.

FIGS. 2 and 3 illustrate example interaction modes that are based on user activity within a 3D environment. Other types or modes of interaction may additionally or alternatively be used including but not limited to user activity via input devices such as keyboards, trackpads, mice, hand-held controllers, and the like. In one example, a user provides an interaction intention via activity (e.g., performing an action such as tapping a button or a trackpad surface) using an input device such as a keyboard, trackpad, mouse, or hand-held controller and a user interface target is identified based on the user's gaze direction at the time of the input on the input device. Similarly, user activity may involve voice commands. In one example, a user provides an interaction intention via activity (e.g., performing an action such as tapping a button or a trackpad surface) using an input device such as a keyboard, trackpad, mouse, or hand-held controller and a user interface target is identified based on the user's gaze direction at the time of the voice command. In another example, user activity identifies an intention to interact (e.g., via a pinch, hand gesture, voice command, input-device input, etc.) and a user interface element is determined based on a non-gaze-based direction, e.g., based on where the user is pointing within the 3D environment. For example, a user may pinch with one hand to provide input indicating an intention to interact while pointing at a user interface button with a finger of the other hand. In another example, a user may manipulate the orientation of a hand-held device in the 3D environment to control a controller direction (e.g., a virtual line extending from controller within the 3D environment) and a user interface element with respect to which the user is interacting may be identified based on the controller direction, e.g., based on identifying what user interface element the controller direction intersects with when input indicating an intention to interact is received.

Various implementations disclosed herein provide an input support process, e.g., as an OS process separate from an executing application, that processes user activity data (e.g., regarding gaze, hand gestures, other 3D activities, HID inputs, etc.) to produce data for an application that the application can interpret as user input. The application may not need to have 3D input recognition capabilities, as the data provided to the application may be in a format that the application can recognize using 2D input recognition capabilities, e.g., those used within application developed for use on 2D touch-screen and/or 2D cursor-based platforms. Accordingly, at least some aspects of interpreting user activity for an application may be performed by processes outside of the application. Doing so may simplify or reduce the complexity, requirements, etc. of the application's own input recognition processes, ensure uniform, consistent input recognition across multiple, different applications, protect private use data from application access, and numerous other benefits as described herein.

FIG. 4 illustrates an exemplary interaction tracking the movements of two hands 422, 424 of the user 102, a gaze along the path 410, and audio/voice data (e.g., audio notification 420) as the user 102 is virtually interacting with a virtual assistant 260 of a user interface 400. In particular, FIG. 4 illustrates an interaction with virtual assistant 260 of the user interface 400 as the user is facing the user interface 400. In this example, the user 102 is using device 105 to view and interact with an XR environment that includes the user interface 400. An interaction recognition process (e.g., direct or indirection interaction) may use sensor data and/or user interface information to determine, for example, which user interface element the user's hand is virtually touching, which user interface element the user intends to interact with, and/or where on that user interface element the interaction occurs. Direct interaction may additionally (or alternatively) involve assessing user activity to determine the user's intent, e.g., did the user intend to a straight tap gesture through the user interface element or a sliding/scrolling motion along the user interface element. Additionally, recognition of user intent may utilize information about the user interface elements. For example, determining user intent with respect to user interface elements may include the positions, sizing, and type of element, types of interactions that are capable on the element, types of interactions that are enabled on the element, which of a set of potential target elements for a user activity accepts which types of interactions, and the like.

Various two-handed gestures may be enabled based on interpreting hand positions and/or movements using sensor data, e.g., image or other sensor data captured by outward facing sensors on an HMD, such as device 105. For example, a pan gesture may be performed by pinching both hands and then moving both hands in the same direction, e.g., holding the hands out at a fixed distance apart from one another and moving them both an equal amount to the right to provide input to pan to the right. In another example, a zoom gesture may be performed by holding the hands out and moving one or both hands to change the distance between the hands, e.g., moving the hands closer to one another to zoom in and farther from one another to zoom out.

Additionally, or alternatively, in some implementations, recognition of such an interaction of two hands may be based on functions performed both via a system process and via an application process. For example, an OS's input support process may interpret hands data from the device's sensors to identify an interaction event and provide limited or interpreted information about the interaction event to the application that provided the user interface 400. For example, rather than providing detailed hand information (e.g., identifying the 3D positions of multiple joints of a hand model representing the configuration of the hand 422 and hand 424), the OS input support process may simply identify a 2D point within the 2D user interface 400 on the user interface element 415 at which the interaction occurred, e.g., an interaction pose. The application process can then interpret this 2D point information (e.g., interpreting it as a selection, mouse-click, touch-screen tap, or other input received at that point) and provide a response, e.g., modifying its user interface accordingly.

In some implementations, hand motion/position may be tracked using a changing shoulder-based pivot position that is assumed to be at a position based on a fixed offset from the device's 105 current position. The fixed offset may be determined using an expected fixed spatial relationship between the device and the pivot point/shoulder. For example, given the device's 105 current position, the shoulder/pivot point may be determined at position X given that fixed offset. This may involve updating the shoulder position over time (e.g., every frame) based on the changes in the position of the device over time. The fixed offset may be determined as a fixed distance between a determined location for the top of the center of the head of the user 102 and the shoulder joint.

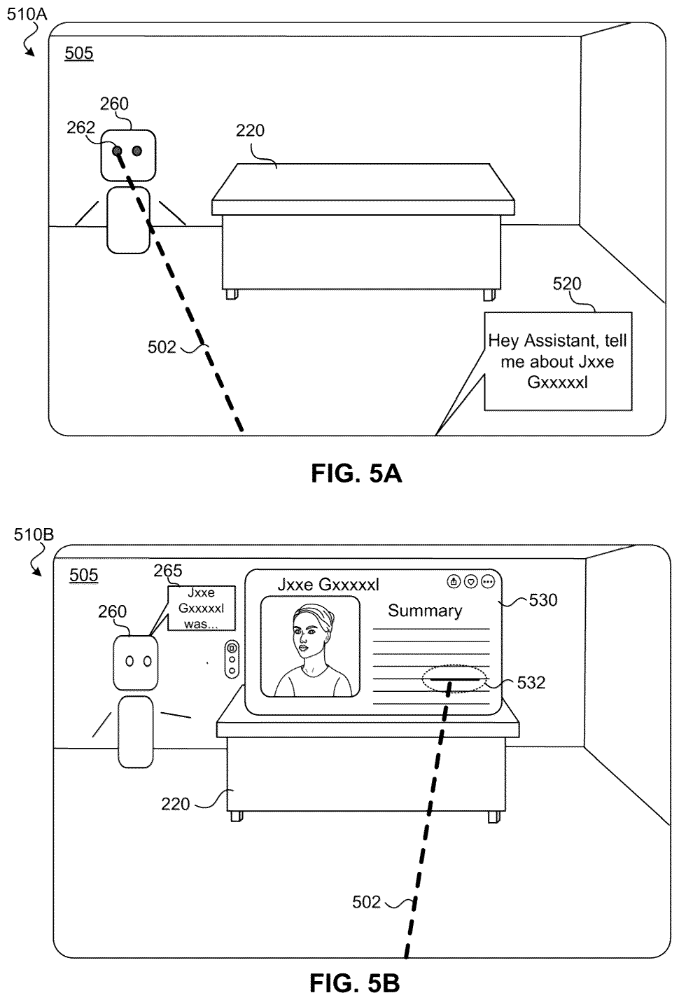

FIGS. 5A, 5B, 6A, 6B, 7A, and 7B illustrate different examples of tracking user activity (e.g., movements of the hands, gaze, voice, etc.) during an interaction of a user attempting to perform a gesture (e.g., user's intent (attention) directed at the user interface element, such as virtual assistant 260) in order to provide an interaction event (e.g., generating one or more user interface elements based on an interaction with virtual assistant 260). For example, each figure illustrates identifying an interaction with the virtual assistant 260 based on tracking a portion of the user (e.g., a gaze, hand movements, or voice of a user) using sensors (e.g., inward or outward facing image sensors and microphones) on a head-mounted device, such as device 105 as the user is moving in the environment and interacting with an environment (e.g., an XR environment). For example, the user may be viewing an XR environment, such as XR environment 205 illustrated in FIG. 2 and/or XR environment 305 illustrated in FIG. 3, and interacting with elements within the application window of the user interface (e.g., virtual assistant 260, user interface 230, etc.) as a device (e.g., device 105) tracks the hand movements and/or gaze of the user 102. The user activity tracking system can then determine if the user is trying to interact with particular user interface elements (e.g., identifying a trigger phrase).

FIGS. 5A and 5B illustrate an example of user activity and interaction recognition with a virtual assistant, and generating a user interface element in response, in accordance with some implementations. FIGS. 5A and 5B are presented in views 510A and 510B, respectively, of an XR environment provided by electronic device 105 and/or electronic device 110 of FIGS. 1A-1B. The views 510A-B of the XR environment 505 includes a view of the representation 220 as the user 102 is interacting with virtual assistant 260.

FIG. 5A illustrates view 510A, for a first instance in time, of a user's 102 voice/audio of a trigger phrase and a command/instruction directed at the virtual assistant 260 as illustrated by voice notification 520 (e.g., “Hey Assistant, tell me about Jxxe Gxxxxl”). Additionally, FIG. 5A illustrates a user's 102 intent (attention) directed at the virtual assistant 260 as illustrated by the gaze along the path 502. Moreover, FIG. 5A further illustrates displaying a graphical indication with the virtual assistant 260 based on identifying a user interaction event with the virtual assistant 260. In other words, the process provides an indication to the user that the system detected an interaction with or an intent to interact with the virtual assistant 260 (e.g., via gaze, hands, or voice data). In this example, the graphical indication 262 distinguishes the eyes of the virtual assistant 260 to graphically to indicate that the virtual assistant 260 is active (e.g., in a “listening mode”) and may try to focus a gaze directly to the user's gaze (e.g., eye contact) based on hearing the trigger phrase and/or detecting the gaze of the user upon the virtual assistant 260.

Additionally, or alternatively, in some implementations, a command to initiate the virtual assistant 260 maybe triggered based on a physiological signal (e.g., gaze) or other input signal associated with the user (e.g., pointing at the assistant) without the need to have a command phrase. For example, a user may trigger the virtual assistant 260 by staring directly at the eyes of or generally towards the virtual assistant 260. In other words, the gaze input is the signal to the system that an utterance is intended for the virtual assistant (e.g., the user looks at the virtual assistant 260 and provides an utterance, “tell me about Jxxx Gxxxl”).

FIG. 5B illustrates view 510B, for a second instance in time, of generating a user interface element (e.g., user interface 530) based on the determined user's 102 intent based on the user activity illustrated in FIG. 5A (e.g., an interaction with virtual assistant 260 and a request for information). The user interface 530 illustrates a 2D informative page (e.g., a webpage) that may be generated based on the user's request for additional information about a particular person. Additionally, FIG. 5B further illustrates different actions for the virtual assistant 260 with respect to the information displayed on the 2D informative page of the user interface 530. For example, in some instances, the virtual assistant 260 may immediately begin reading some or all of the text displayed on the user interface 530 (e.g., the Summary section), as illustrated by the audio notification 265 (e.g., “Jxxe Gxxxxl was . . . ”). In some implementations, the virtual assistant 260 may read the text verbatim (word-for-word), may paraphrase the content, or may determine different content about the displayed information to provide the user (e.g., from another LLM). Moreover, FIG. 5B further illustrates the user's gaze along the path 502 upon the particular area 532 on the user interface 530. The particular area 532 may be highlighted by the system because the user's gaze is focused on that portion, or because the virtual assistant determines that is an important aspect of the information displayed on the user interface 530, and thus directs the user's attention (e.g., gaze) towards that portion (e.g., area 532).

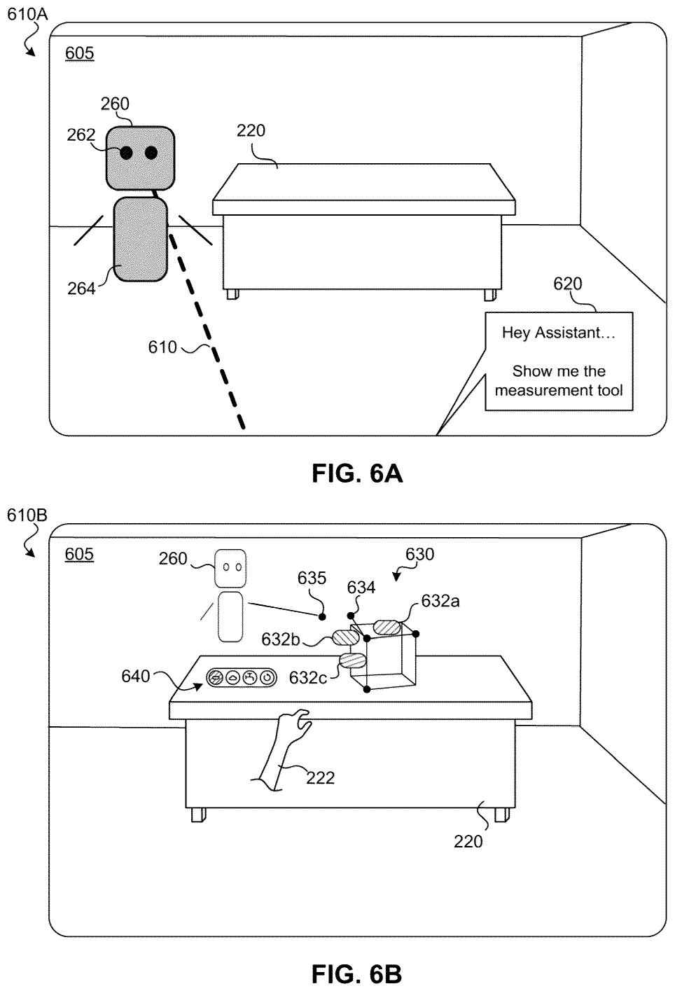

FIGS. 6A and 6B illustrate views of an example of user activity and interaction recognition with a virtual assistant, and generating a user interface element in response, in accordance with some implementations. FIGS. 6A and 6B are presented in views 610A and 610B, respectively, of an XR environment provided by electronic device 105 and/or electronic device 110 of FIGS. 1A-1B. The views 610A-B of the XR environment 605 includes a view of the representation 220 as the user 102 is interacting with virtual assistant 260.

FIG. 6A illustrates view 610A, for a first instance in time, of a user's 102 voice/audio of a trigger phrase and then providing a command/instruction directed at the virtual assistant 260 as illustrated by voice notification 620 (e.g., “Hey Assistant. . . . Show me the measurement tool”). Additionally, FIG. 6A illustrates a user's 102 intent (attention) directed at the virtual assistant 260 as illustrated by the gaze along the path 610. Moreover, FIG. 6A further illustrates displaying a graphical indication with the virtual assistant 260 based on identifying a user interaction event with the virtual assistant 260. In other words, the process provides an indication to the user that the system detected an interaction with or an intent to interact with the virtual assistant 260 (e.g., via gaze, hands, or voice data). In this example, the graphical indication 262 distinguishes the eyes, and the graphical indication 264 distinguishes the overall color or shading of the virtual assistant 260 to graphically indicate that the virtual assistant 260 is active (e.g., in a “listening mode”) and may try to focus a gaze directly to the user's gaze (e.g., eye contact) based on hearing the trigger phrase and/or detecting the gaze of the user upon the virtual assistant 260.

FIG. 6B illustrates view 610B, for a second instance in time, of generating a user interface element (e.g., application 630) based on the determined user's 102 intent based on the user activity illustrated in FIG. 6A (e.g., an interaction with virtual assistant 260 and a request for a specific application, e.g., a measurement tool). The application 630 illustrates a 3D interactive model for creating 3D measurements that may be generated based on the user's request for the measurement tool (e.g., displays measurements between selectable/movable endpoints). For example, the application 630 includes measurement data 632a, 632b, and 632c (e.g., measurements between two endpoints), as well as additional options displayed on a separate window (e.g., toolbar 640). Additionally, FIG. 6B further illustrates different actions for the virtual assistant 260 with respect to the information displayed on the 3D interactive model of the application 630. For example, as illustrated, the virtual assistant 260 is directing the user's 102 attention to a small or minute detail (e.g., endpoint 634 is misplaced) based on the 3D endpoint 635 (e.g., the virtual assistant is pointing to an endpoint on the application) as the user is attempting to reach out to an endpoint as shown by representation 222 (e.g., to drag and drop endpoints to calculate a distance between two endpoints).

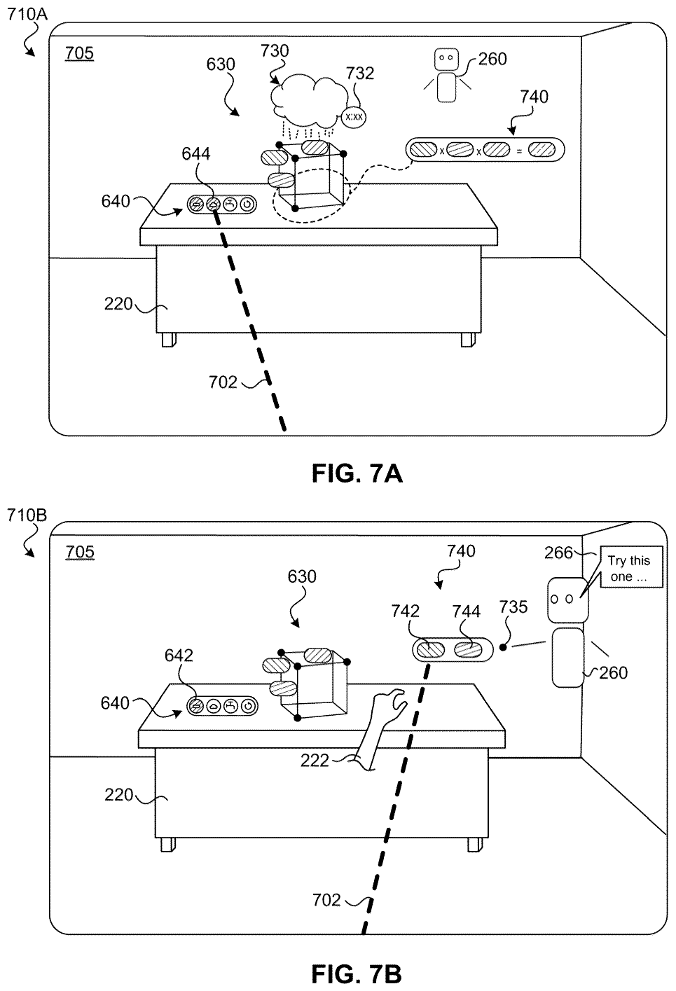

FIGS. 7A-7B illustrate views of an example of user activity and interaction recognition with a virtual assistant, and generating a user interface element in response, in accordance with some implementations. FIGS. 7A and 7B are presented in views 710A and 710B, respectively, of an XR environment provided by electronic device 105 and/or electronic device 110 of FIGS. 1A-1B. The views 710A-B of the XR environment 705 includes a view of the representation 220 as the user 102 is interacting with virtual assistant 260 and the application 630 of FIG. 6.

FIG. 7A illustrates view 710A, for a first instance in time, of a user's 102 attention directed towards a particular application on the toolbar 640, as illustrated by the user's gaze along the path 702 (e.g., an indirect interaction based on gaze and/or pointing). In particular, the user 102 is directing his or her attention and selecting the cloud application 644, which generates a 3D cloud application 730 to provide virtual rain into the virtual box for the application 630. The concept of the 3D cloud application 730 is to fill the virtual box with water and then calculate a volume, which is illustrated by a volume calculation window at toolbar 740 (e.g., height x length x width). The 3D cloud application 730 may include a water timer element 732 that provides a timer (e.g., to illustrate the amount of time elapsed while filling the box with water). Additionally, FIG. 7A illustrates the virtual assistant 260 in a standby mode looking at the actions of the user and waiting for further instructions from the user or an opportunity to assist the user (if needed).

FIG. 7B illustrates view 710B, for a second instance in time, of a user's 102 attention directed towards a particular application on the toolbar 740, as illustrated by the user's gaze along the path 702 (e.g., an indirect interaction based on gaze and/or pointing). In particular, the user 102 is directing his or her attention to the toolbar 740 and is about to select element 742 which is associated with a particular portion of the measurement tool (e.g., element 642) for application 630. However, the virtual assistant 260 is directing the user's 102 attention to select element 744 based on the 3D endpoint 735 (e.g., the virtual assistant is pointing to the correct element 744 on the application) as the user is attempting to reach out to element 742 as shown by representation 222. Additionally, FIG. 7B illustrates the virtual assistant providing a verbal interaction in addition to the pointing and the 3D endpoint 735, as illustrated by the audio notification 266 (e.g., “Try this one . . . ”). In other words, the virtual assistant 260 identifies that the user 102 may be making an incorrect selection and is encouraging the user to select element 744.

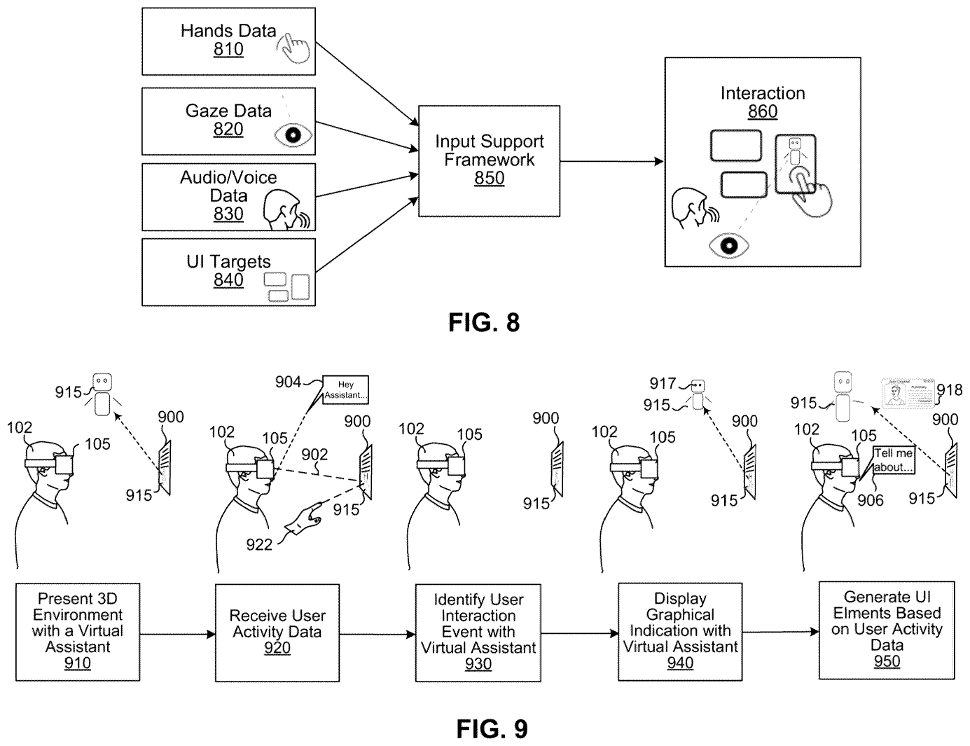

FIG. 8 illustrates use of an exemplary input support framework 850 to generate interaction data 860 based on hands data 810, gaze data 820, audio/voice data 830, and user interface target data 840. The interaction data 860 can then be provided to one or more applications and/or used by system processes to provide a desirable user experience. In some implementations, the input support process is configured to understand a user's intent to interact, generate input signals and events to create reliable and consistent user experiences across multiple applications, detect input out-of-process and route it through the system responsibly. The input support process may arbitrate which application, process, and/or user interface element should receive user input, for example, based identifying which application or user interface element is the intended target of a user activity. The input support process may keep sensitive user data, e.g., gaze, hand/body enrollment data, etc., private; only sharing abstracted or high-level information with applications.

The input support process may take hands data 810, gaze data 820, audio/voice data 830, and user interface target data 840 and determine user interaction states. In some implementations, it does so within a user environment in which multiple input modalities are available to the user, e.g., an environment in which a user can interact directly as illustrated in FIG. 2 (e.g., user reaches out and appears to touch the 3D position of the user interface element) or indirectly as illustrated in FIG. 3 (e.g., based on the user's gaze, hand movements, voice, or a combination thereof) to achieve the same interactions with user interface elements. For example, the input support process may determine that the user's right hand is performing an intentional pinch and gaze interaction with a user interface element, that the left hand is directly tapping a user interface element, or that the left hand is fidgeting and therefor idle/doing nothing relevant to the user interface. In some implementations, the user interface target data 840 includes information associated with the user interface elements, such as scalable vector graphics (SVG) information for vector graphics (e.g., may have some information from the basic shapes, paths, or may contain masks or clip paths) and/or other image data (e.g., RGB data or image metadata for bitmap images).

Based on determining a user intent to interact, the input support framework 850 may generate interaction data 860 (e.g., including an interaction pose, manipulator pose, and/or interaction state). The input support framework may generate input signals and events that applications may consume without needed custom or 3D input recognition algorithms in process. In some implementations, the input support framework provides interaction data 860 in a format that an application can consume as a touch event on a touch screen or as track pad tap with a 2D cursor at a particular position. Doing so may enable the same application (with little or no additional input recognition processes) to interpret interactions across different environments including new environment for which an application was not originally created and/or using new and different input modalities. Moreover, application responses to input may be more reliable and consistent across applications in a given environment and across different environments, e.g., enabling consistent user interface responses for 2D interactions with the application on tablets, mobile devices, laptops, etc. as well as for 3D interactions with the application on an HMD and/or other 3D/XR devices.

The input support framework may also manage user activity data such that different apps are not aware of user activity relevant to other apps, e.g., one application will not receive user activity information while a user types a password into another app. Doing so may involve the input support framework accurately recognizing to which application a user's activity corresponds and then routing the interaction data 860 to only the right application. An application may leverage multiple processes for hosting different user interface elements (e.g., using an out-of-process photo picker) for various reasons (e.g., privacy). The input support framework may accurately recognize to which process a user's activity corresponds and route the interaction data 860 to only the right process. The input support framework may use details about the UIs of multiple, potential target apps and/or processes to disambiguate input.

In some implementations, the input support framework 850 includes a natural language processing module (e.g., a large language model (LLM)) to process the audio/voice data 830. A natural language processing module (“natural language processor”) may take the n-best candidate text representation(s) (“word sequence(s)” or “token sequence(s)”) generated by a speech-to-text (STT) processing module processing module and may attempt to associate each of the candidate text representations with one or more “actionable intents” recognized by a digital assistant (e.g., virtual assistant 260). In some embodiments, an STT processing module may attempt to associate each of the candidate text representation with one or more “candidate intents” using a false trigger mitigator (FTM). The FTM may provide the candidate intents to a candidate intent evaluator (CIE), which evaluates whether the candidate intents include one or more “actionable intent.” An “actionable intent” (or “user intent”) represents a task that can be performed by the digital assistant (e.g., virtual assistant 260), and can have an associated task flow implemented in task flow models (e.g., “tell me about Jxxe Gxxxxl”, “show me clouds”, etc.). The associated task flow is a series of programmed actions and steps that the digital assistant takes in order to perform the task. The scope of a digital assistant's capabilities is dependent on the number and variety of task flows that have been implemented and stored in task flow models, or in other words, on the number and variety of “actionable intents” that the digital assistant (e.g., virtual assistant 260) recognizes. The effectiveness of the digital assistant, however, also dependents on the assistant's ability to infer the correct “actionable intent(s)” from the user request expressed in natural language. Other details of a natural language processing system is described in U.S. patent application Ser. No. 16/019,331 for “Natural Assistant Interaction,” filed Jun. 26, 2018, the entire disclosure of which is incorporated herein by reference.

In some examples, using the processing modules, data, and models implemented in a virtual assistant module for the virtual assistant 260 as part of the input support framework 850, the virtual assistant 260 may perform at least some of the following: converting speech input into text; identifying a user's intent expressed in a natural language input received from the user; actively eliciting and obtaining information needed to fully infer the user's intent (e.g., by disambiguating words, games, intentions, etc.); determining the task flow for fulfilling the inferred intent; and executing the task flow to fulfill the inferred intent.

In some implementations, in response to detecting interactions based on user activity data, the interaction data 860 may include generating one or more user interface elements that are positioned at 3D positions based on the 3D coordinate system associated with the 3D environment. For example, based on interactions with the virtual assistant 260, the system may generate or alter/update user interface elements that may include a 2D informative page, associated video/images, and/or 3D interactive models such as virtual clouds. In some implementations, the LLM of the input support framework 850 may customize an experience of the generated user interface elements for a user (e.g., one or more attributes of the virtual assistant 260 such as a type of LLM, a type of personality, a response style, a temperature style, a pedagogical approach selection, or a combination thereof). In some implementations, the virtual assistant 260 may talk during the experience and voice the information or may voice different information (e.g., not word for word what's on the info page).

It should be recognized that in some examples, natural language processing of the input support framework 850 may be implemented using one or more machine learning mechanisms (e.g., neural networks). In particular, the one or more machine learning mechanisms are configured to receive a candidate text representation and contextual information associated with the candidate text representation. Based on the candidate text representation and the associated contextual information, the one or more machine learning mechanism are configured to determine intent confidence scores over a set of candidate actionable intents. A natural language processing module of the input support framework 850 may select one or more candidate actionable intents from the set of candidate actionable intents based on the determined intent confidence scores. In some examples, an ontology may also be used to select the one or more candidate actionable intents from the set of candidate actionable intents. Other details of searching an ontology based on a token string is described in U.S. patent application Ser. No. 12/341,743 for “Method and Apparatus for Searching Using An Active Ontology,” filed Dec. 22, 2008, the entire disclosure of which is incorporated herein by reference.

FIG. 9 illustrates an example of interaction recognition of user activity with a virtual assistant and generating one or more user interface elements in response. In this example, sensor data on device 105 and/or user interface information are used to recognize a user interaction made by user 102, e.g., based on inward or outward-facing image sensor data, audio data via a microphone, depth sensor data, eye sensor data, motion sensor data, etc. and/or information made available by an application providing the user interface. Sensor data may be monitored to detect user activity corresponding to an engagement condition corresponding to the start of a user interaction.

In this example, at block 910, the process presents a 3D environment (e.g., an XR environment) with a virtual assistant that includes a view of a virtual assistant 915 and, optionally, a user interface 900 that includes virtual elements/objects. At block 920 the process receives user activity data such as hands data, gaze information (e.g., gaze direction 902 of user 102), and/or audio/voice information (e.g., voice notification 904). In an exemplary implementation, the process may detect a trigger phrase (e.g., “Hey Assistant”) as illustrated by voice notification 904. In some implementations, the process may detect that the user 102 has positioned a hand 922 within view of outward facing image sensors. In some implementations, the process may detect one or more particular one-handed or two-handed configurations, e.g., a claw shape, a pinch, a point, a flat hand, a steady hand in any configuration, etc., as an indication of hand engagement or may simply detect the presence of the hand within sensor view to initiate a process.

At block 930, the process identifies a user interaction event with a virtual assistant. In an exemplary embodiment, the process recognizes a trigger phrase of the user (e.g., “Hey Assistant”). In some implementations, the process may identify that the gaze direction 905 of user 102 and/or a pointing direction of the hand 922 is directed towards (e.g., an indirect interaction) the virtual assistant 915 (or any other object within a view of an XR environment). However, the process may identify the object (e.g., virtual assistant 915) based only on gaze, only on voice, or only on hand activity. Additionally, or alternatively, in some implementations, a command to initiate the virtual assistant 915 maybe triggered based on a physiological signal (e.g., gaze) or other input signal associated with the user (e.g., pointing at the assistant) without the need to have a command phrase. For example, a user may trigger the virtual assistant 915 by staring directly at the eyes of or generally towards the virtual assistant 915. In other words, the gaze input is the signal to the system that an utterance is intended for the virtual assistant 915 (e.g., the user looks at the virtual assistant 915 and then provides an utterance/command, “tell me about Jxxx Gxxxl”).

At block 940, the process displays a graphical indication with the virtual assistant 915 based on the identified user interaction event with the virtual assistant 915. In other words, the process provides an indication to the user that the system detected an interaction with or an intent to interact with the virtual assistant 915 (e.g., via gaze, hands, or voice data). In this example, the graphical indication 917 distinguishes the eyes of the virtual assistant 915 to graphically to indicate that the virtual assistant 915 is active and may try to focus a gaze directly to the user's gaze (e.g., eye contact). In other examples, the virtual assistant 915 may provide other indications of being active other than the eyes, such as head movements, body movements, audio indications (e.g., “I am Assistant, how can I help you?”), a combination of each, and the like. In some implementations, after detecting a user interaction event, the virtual assistant 915 may become more animated with multiple movements, change shape and/or color, and/or turn into a different character (e.g., change from a robot to an animal or another virtual character).

At block 950, the process generates user interface elements based on user activity data. In this example, the user 102 is gazing at and asking the virtual assistant 915 to “Tell me about . . . ” (e.g., voice notification 906), which may be interpreted to initiate an action upon the virtual assistant 915. For example, the interpretation of the voice notification 906 causes the system to initiate an information page 918 based on the instructions provided by the user 102. As discussed herein with reference to FIGS. 5A and 5B, the virtual assistant 915 may then proceed to move and direct the user's 102 attention towards the information page 918 while reading some or all of the text displayed on the information page 918. In some implementations, the contents of page 918 may be obtained from one or more sources. For example, the contents of page 918 may be obtained from, but not limited to sources such as, inter alia, text from LLM, a webpage retrieved from the internet, text/images/3D models retrieved from the internet, images 3D models created using generative Al based on text from LLM, a combination thereof, or the like.

In some implementations, the application that provided the information page 918 need not be notified of the interactions with the virtual assistant 915. Instead, the gaze, hand, and/or audio/voice engagement, object identification, and display of the information page 918 can be handled out of a process (e.g., outside of the application process), e.g., by the operating system processes. For example, such processes may be provided via an operating system's input support process. Doing so may reduce or minimize potentially sensitive user information (e.g., such as constant gaze direction vectors, hand motion direction vectors, or voice data) that might otherwise be provided to the application to enable the application to handle these functions within the application process. Whether and how to display feedback may be specified by the application even though it is carried out of a process. For example, the application may define that an element should display hover or highlight feedback and define how the hover or highlight will appear such that the out of process aspect (e.g., operating system) may provide the hover or highlight according to the defined appearance. Alternatively, feedback can be defined out-of-process (e.g., solely by the OS) or defined to use a default appearance/animation if the application does not specify an appearance.

Recognition of such an interaction with a user interface element may be based on functions performed both via a system process and via an application process. For example, an OS's input process may interpret voice data, hands data, and optionally gaze data from the device's sensors to identify an interaction event and provide limited or interpreted/abstracted information about the interaction event to the application that provided the user interface 900 or other user interface elements. For example, rather than providing gaze direction information identifying gaze direction 902, the OS input support process may identify a 2D point within the 2D user interface 900 on the virtual assistant 915, e.g., an interaction pose. The application process can then interpret this 2D point information (e.g., interpreting it as a selection, mouse-click, touch-screen tap, or other input received at that point) and provide a response, e.g., modifying its user interface accordingly.

FIG. 9 illustrates examples of recognizing indirect user interactions in order to determine whether or not to display virtual assistant 915 feedback (e.g., generated user interface elements) and graphical indications as feedback (e.g., activate virtual assistant 915). Numerous other types of indirect interactions can be recognized, e.g., based on one or more user actions identifying a user interface element and/or one or more user actions providing input (e.g., no-action/hover type input, selection type input, input having a direction, path, speed, acceleration, etc.). Input in 3D space that is analogous to input on 2D interfaces may be recognized, e.g., input analogous to mouse movements, mouse button clicks, touch screen touch events, trackpad events, joystick events, game controller events, etc.

Some implementations utilize an out of process (e.g., outside of an application process) input support framework to facilitate accurate, consistent, and efficient input recognition in a way that preserves private user information. For example, aspects of the input recognition process may be performed out of process such that applications have little or no access to information about where a user is looking, e.g., gaze directions. In some implementations, application access to some user activity information (e.g., gaze direction-based data) is limited to only a particular type of user activity, e.g., activity satisfying particular criteria. For example, applications may be limited to receive only information associated with deliberate or intentional user activity, e.g., deliberate or intentional actions indicative of an intention to interact with (e.g., select, activate, move, etc.) a user interface element.

Some implementations recognize input using functional elements performed both via an application process and a system process that is outside of the application process. Thus, in contrast to a framework in which all (or most) input recognition functions are managed within an application process, some algorithms involved in the input recognition may be moved out of process, e.g., outside of the application process. For example, this may involve moving algorithms that detect gaze input and intent out of an application's process such that the application does not have access to user activity data corresponding to where a user is looking or only has access to such information in certain circumstances, e.g., only for specific instances during which the user exhibits an intent to interact with a user interface element.

Some implementations recognize input using a model in which an application declares or otherwise provides information about its user interface elements so that a system process that is outside of the application process can better facilitate input recognition. For example, an application may declare the locations and/or user interface behaviors/capabilities of its buttons, scroll bars, menus, objects, and other user interface elements. Such declarations may identify how a user interface should behave given different types of user activity, e.g., this button should (or should not) exhibit hover feedback when the user looks at it.

The system process (e.g., outside of the application process) may use such information to provide the desired user interface behavior (e.g., providing virtual assistant feedback with a graphical indication in appropriate user activity circumstances). For example, the system process may trigger the graphical indication (virtual assistant feedback) for a user interface element based on a declaration from the application that the app's user interface includes the element and that it should display virtual assistant feedback, e.g., when gazed upon the virtual assistant eye's change and look directly at the user 102. The system process may provide such virtual assistant feedback based on recognizing the triggering user activity (e.g., gaze at the virtual assistant) and may do so without revealing to the application the user activity details associated with the user activity that triggered the virtual assistant, the occurrence of the user activity that triggered the virtual assistant feedback, and/or that the virtual assistant feedback was provided. The application may be unaware of the user's gaze direction and/or that virtual assistant feedback was provided for the user interface element.

Some aspects of input recognition may be handled by the application itself, e.g., in process. However, the system process may filter, abstract, or otherwise manage the information that is made available to the application to recognize input to the application. The system process may do so in ways that facilitate input recognition that is efficient, accurate, consistent (within the application and across multiple applications), and that allow the application to potentially use easier-to-implement input recognition and/or legacy input recognition processes, such as input recognition processes developed for different systems or input environment, e.g., using touch screen input processes used in legacy mobile apps.

Some implementations use a system process to provide interaction event data to applications to enable the applications to recognize input with the virtual assistant or with other user interface elements. The interaction event data may be limited so that all user activity data is not available to the applications. Providing only limited user activity information may help protect user privacy. The interaction event data may be configured to correspond to events that can be recognized by the application using a general or legacy recognition process. For example, a system process may interpret 3D user activity data to provide interaction event data to an application that the application can recognize in the same way that the application would recognize a touch event on a touch screen. In some implementations, an application receives interaction event data corresponding to only certain types of user activity, e.g., intentional, or deliberate actions on user interface objects, and may not receive information about other types of user activity, e.g., voice only or gaze only activities, a user moving their hands in ways not associated with user interface interactions, a user moving closer to or further away from the user interface, etc. In one example, during a period of time (e.g., a minute, 10 minutes, etc.) a user gazes around a 3D XR environment including gazes at certain user interface text, buttons, and other user interface elements and eventually performs an intentional user interface interaction, e.g., by making an intentional pinch gesture while gazing at button X. A system process may handle all of the user interface and virtual assistant feedback during the gazing around at the various user interface elements without providing the application information about these gazes. On the other hand, the system process may provide interaction event data to the application based on the intentional pinch gesture while gazing at button X. However, even this interaction event data may provide limited information to the application, e.g., providing an interaction position or pose identifying an interaction point on button X without providing information about the actual gaze direction. The application can then interpret this interaction point as an interaction with the button X and respond accordingly. Thus, user behavior that is not associated with intentional user interactions with user interface elements (e.g., gaze only hover, menu expansion, reading, etc.) are handled out of process without the application having access to user data and the information about the intentional user interface element interactions is limited such that it does not include all of the user activity details.

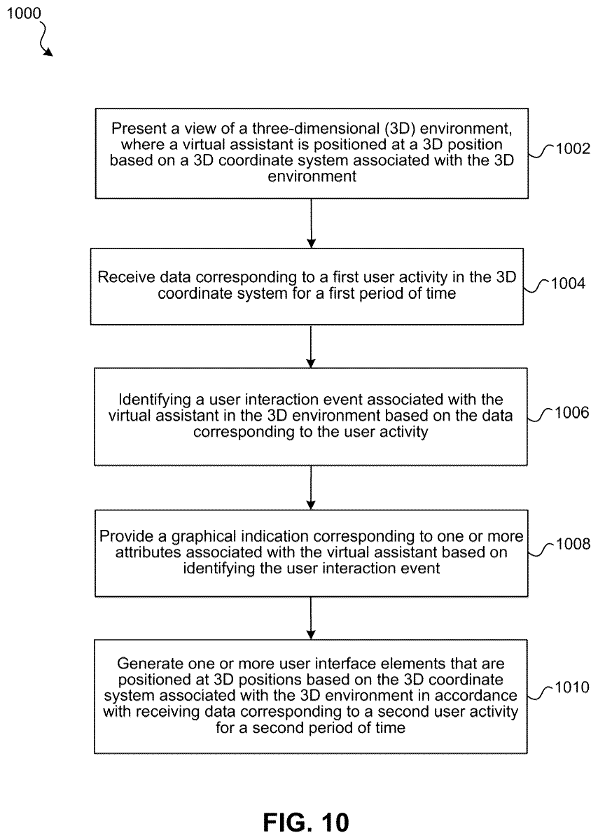

FIG. 10 is a flowchart illustrating a method 1000 for generating one or more user interface elements based on identifying a user interaction event corresponding to the user activity with a virtual assistant, in accordance with some implementations. In some implementations, a device such as electronic device 105 or electronic device 110 performs method 1000. In some implementations, method 1000 is performed on a mobile device, desktop, laptop, HMD, or server device. The method 1000 is performed by processing logic, including hardware, firmware, software, or a combination thereof. In some implementations, the method 1000 is performed on a processor executing code stored in a non-transitory computer-readable medium (e.g., a memory).

Various implementations of the method 1000 disclosed herein present a real-time intelligent virtual assistant using an LLM that provides natural assistant interactions in an XR environment using a 3D display device (e.g., a wearable device such as an HMD (device 105)) based on a user's intent (attention) directed at the virtual assistant. In some embodiments, the intelligent virtual assistant may be embodied as an artificial intelligence (AI) tutor within with a user's space (e.g., a view of a three-dimensional (3D) environment, such as a mixed reality view). The intelligent virtual assistant may be triggered (e.g., activated) by gaze, voice activation (via a trigger phrase such as “Hey Assistant”), or by other detection of user interactions (e.g., hand-based interaction data). In some embodiments, the intelligent virtual assistant may generate multiple user interface elements based on the user input to customize the experience. For example, a user may initiate an interaction by stating, e.g., “show me clouds”, and the intelligent virtual assistant may generate a two-dimensional (2D) page for general knowledge based information of clouds, an additional page (widget) for video/images of different clouds, a 3D interactive model of one or more clouds, and/or change the entire theme of a current view of the room/experience (e.g., display a ceiling of virtual clouds). In some embodiments, the intelligent virtual assistant may direct a user's attention to a learning objective (e.g., a single endpoint), guide a user with multiple endpoints for a step-by-step process, and/or manipulate the 3D environment by moving endpoints or virtual objects. In some embodiments, the intelligent virtual assistant may be personalized to each user and adjusted based on physiological cues of the user, or teaching methods that pertain to the user (e.g., learning math as a fourth grader compared to a college student). In some embodiments, one or more attributes of the intelligent virtual assistant may be adjusted based on context (e.g., happy vs sad eyes, facial expressions, body language, voice tone, etc.).

At block 1002, the method 1000 presents a view of a 3D environment, where a virtual assistant is positioned at a 3D position based on a 3D coordinate system associated with the 3D environment. For example, as illustrated in FIGS. 2A, 2B, and 3, user interface elements, such as a 2D page (e.g., user interface 230) and a virtual assistant 260, may be viewed using a 3D device (e.g., device 105). In some implementations, at an input support process, the process includes obtaining data corresponding to positioning of user interface elements of the application within a 3D coordinate system. The data may correspond to the positioning of the user interface element based at least in part on data (e.g., positions/shapes of 2D elements intended for a 2D window area) provided by the application, for example, such as user interface information provided from an application to operating system process. In some implementations, the operating system manages information about a virtual and/or real content positioned within a 3D coordinate system. Such a 3D coordinate system may correspond to an XR environment representing the physical environment and/or virtual content corresponding to content from one or more apps. The executing application may provide information about the positioning of its user interface elements via a layered tree (e.g., a declarative, hierarchical layer tree) with some layers identified for remote (i.e., out of app process) input effects.

At block 1004, the method 1000 receives data corresponding to a first user activity in the 3D coordinate system for a first period of time. For example, user activity data may include audio/voice data, hands data, gaze data, or data corresponding to other input modalities (e.g., an input controller). As described with respect to FIG. 9, such data may include but is not limited to including hands data, gaze data, audio/voice data, and/or human interface device (HID) data. A single type of data or various combinations of two or more different types of data may be received, e.g., voice data and gaze data, controller data and gaze data, hands data and controller data, hands data and gaze data, voice data and hands data, etc. Different combinations of sensor/HID data may correspond to different input modalities. In one exemplary implementation, the data includes both hands data (e.g., a hand pose skeleton identifying 20+ joint locations) and gaze data (e.g., a stream of gaze vectors), and both the hands data and gaze data may both be relevant to recognizing input via a direct touch input modality and an indirect touch input modality.

At block 1006, the method 1000 identifies a user interaction event associated with the virtual assistant in the 3D environment based on the data corresponding to the user activity. For example, a user interaction event may be based on whether the user intends to interact with the virtual assistant 260 by speaking a trigger phrase, such as “Hey Assistant”. In some implementations, a user interaction event may be based on determining whether a user is focused (attentive) towards a particular object (e.g., a user interface element such as virtual assistant 260) using voice interactions with gaze and/or pinch data based on the direction of eye gaze, head, hand, arm, etc. In some implementations, identifying the user interaction event may be based on determining that a pupillary response corresponds to directing attention to a region associated with the user interface element. In some implementations, identifying the user interaction event may be based on a finger point and hand movement gesture. In some implementations, the user interaction event is based on a direction of a gaze or a face of a user with respect to the user interface. The direction of a face of a user with respect to the user interface may be determined by extending a ray from a position on the face of the user and determining that the ray intersects the visual element on the user interface.

At block 1008, in accordance with identifying the user interaction event, the method 1000 provides a graphical indication corresponding to one or more attributes associated with the virtual assistant. In other words, the process provides an indication to the user that the system detected an interaction with or an intent to interact with the virtual assistant 260 (e.g., via gaze, hands, or voice data) and thus the virtual assistant turns to a “listening mode”. In some implementations, the graphical indication is a virtual effect corresponding to an eye or pair of eyes associated with the virtual assistant (e.g., eyes change based on the current mode, listening, speaking, etc.). For example, as illustrated in FIG. 5A the graphical indication 262 distinguishes the eyes of the virtual assistant 260 to graphically to indicate that the virtual assistant 260 is active and tries to focus a gaze directly to the user's gaze (e.g., to make eye contact). In other examples, the virtual assistant 260 may provide other indications of being active other than the eyes, such as head movements, body movements, audio indications (e.g., “I am Assistant, how can I help you?”), a combination of each, and the like. In some implementations, after detecting a user interaction event, the virtual assistant 260 may become more animated with multiple movements, change shape and/or color, and/or turn into a different character (e.g., change from a robot to an animal or another virtual character).

At block 1010, the method 1000 generates one or more user interface elements that are positioned at 3D positions based on the 3D coordinate system associated with the 3D environment in accordance with receiving data corresponding to a second user activity for a second period of time. For example, the method 1000 generates user interface elements based on user activity data. As illustrated in FIG. 9, the user 102 is gazing at and asking the virtual assistant 915 to “Tell me about . . . ” (e.g., voice notification 906), which may be interpreted to initiate an action upon the virtual assistant 915. For example, the interpretation of the voice notification 906 causes the system to initiate an information page 918 based on the instructions provided by the user 102. As discussed herein with reference to FIGS. 5A and 5B, the virtual assistant 915 may then proceed to move and direct the user's 102 attention towards the information page 918 while reading some or all of the text displayed on the information page 918. For example, based on interactions with the virtual assistant 915, the system may generate or alter/update user interface elements that may include a 2D informative webpage, associated video/images, and/or 3D interactive models such as virtual clouds.

In some implementations, the one or more user interface elements are customized based on a large language model (LLM) associated with the virtual assistant. In some implementations, the system may customize an experience of the generated user interface elements for a user (e.g., one or more attributes of the virtual assistant 260 such as a type of LLM, a type of personality, a response style, a temperature style, a pedagogical approach selection, or a combination thereof). For example, the virtual assistant may have a different “brain” for the type of LLM, such as a different source for the LLM. The virtual assistant may have a different type of personality (and voice) based on the user's attributes or based on a selection of the user (e.g., neutral, granny, surfer, sassy, etc.). The virtual assistant may have a different response style such as a long response or a short response. The virtual assistant may have a different temperature with the responses such as factual responses to creative response. The virtual assistant may optionally include a pedagogical approach with the interactions with the user (e.g., either toggled on or off based on the type of user, such as student, or selection by the user to turn on a teaching mode, etc.). In some implementations, the virtual assistant 260 may talk during the experience and voice the information or may voice different information (e.g., not word for word what's on the info page).

In some implementations, generating the one or more user interface elements includes determining one or more candidate representations based on a determined context of the one or more utterances. In some implementations, the one or more candidate representations are updated based on data corresponding to user activity for a second period of time. For example, updating the user interface elements based on user interactions with the virtual assistant or one of the user interface elements. In other examples, the system may detect, via gaze detection, that the user is reading the text on one of the user interface elements and then automatically updates the user interface element with additional text, or changes the photos/videos based on user intent detection at either content.

In some implementations, the one or more candidate representations includes a candidate text representation (e.g., 2D informative text), a candidate audio representation (e.g., virtual assistant's voice, which may be different than the 2D text), a candidate image representation (e.g., associated image(s)), a candidate video representation (e.g., associated video(s)), and/or a candidate virtual object representation (e.g., 3D interactive models). In some implementations, the candidate virtual object representation includes a 3D interactive model. For example, as illustrated in FIG. 6B with the virtual box measurement tool, the virtual assistant 260 can direct a user's attention to a learning objective (e.g., a single endpoint), guide a user with multiple endpoints for a step-by-step process, and/or manipulate the 3D environment by moving endpoints or virtual objects.

In some implementations, the method 1000 may further include providing a stream of spatialized audio at a 3D position within the 3D coordinate system associated with the 3D environment, wherein the 3D position of the stream of spatialized audio corresponds to the 3D position of the virtual assistant. In other words, spatialized audio can pinpoint a source of the audio (e.g., voice of the virtual assistant) to the 3D position/location of the virtual assistant for more realistic interactions. In some implementations, utterances associated with the stream of spatialized audio are correlated to utterances associated with the candidate text representation. Additionally, or alternatively, in some implementations, utterances associated with the stream of spatialized audio are different than the candidate text representation. For example, the virtual assistant may talk during the experience and voice the information or may voice different information (e.g., not word for word what's on the info page, may be generated by a different LLM that provides more realistic spoken words than the candidate audio representation). For example, as illustrated in FIG. 5B, the text of the Summary section of the user interface 530 may be different than the words spoken by the virtual assistant 260.

In some implementations, the method 1000 may further include determining a context of a user based on at least one of the first user activity, the second user activity, and one or more physiological cues of the user, and updating the graphical indication of the virtual assistant is based on the determined context. For example, the system may determine a type of context associated with the interactions with the virtual assistant and update the virtual assistant accordingly (e.g., sad/gloomy eyes if a sad topic/interactions, happy eyes and expressions if a happy topic/interactions). In some implementations, the system may determine a type of context associated with the interactions with the virtual assistant based on physiological cues from the user (e.g., a tone of voice, voice inflections, crying, laughing, etc.).

In some implementations, the interaction event data may include an interaction pose (e.g., 6DOF data for a point on the app's user interface), a manipulator pose (e.g., 3D location of the stable hand center or pinch centroid), an interaction state (e.g., direct, indirect, hover, pinch, etc.) and/or identify which user interface element is being interacted with. In some implementations, the interaction data may exclude data associated with user activity occurring between intentional events. The interaction event data may exclude detailed sensor/HID data such as hand skeleton data. The interaction event data may abstract detailed sensor/HID data to avoid providing data to the application that is unnecessary for the application to recognize inputs and potentially private to the user.

In some implementations, the method 1000 may display a view of an extended reality (XR) environment corresponding to the (3D) coordinate system, where the user interface elements of the application are displayed in the view of the XR environment. Such an XR environment may include user interface elements from multiple application processes corresponding to multiple applications and the input support process may identify the interaction event data for the multiple applications and route interaction event data to only the appropriate applications, e.g., the applications to which the interactions are intended by the user. Accurately routing data to only the intended applications may help ensure that one application does to misuse input data intended for another application (e.g., one application does not track a user entering a password into another application).

In some implementations, the data corresponding to the first user activity or the data corresponding to the second user activity (e.g., user activity data) may have various formats and be based on or include (without being limited to being based on or including) sensor data (e.g., hands data, gaze data, head pose data, etc.) or HID data. In some implementations, the user activity data includes audio stream that includes one or more utterances (e.g., “Hey Assistant, tell me about . . . ”). In some implementations, the user activity data includes gaze data including a stream of gaze vectors corresponding to gaze directions over time during use of the electronic device. The user activity data may include hands data including a hand pose skeleton of multiple joints for each of multiple instants in time during use of the electronic device. The user activity data may include both hands data and gaze data. The user activity data may include controller data and gaze data. The user activity data may include, but is not limited to, any combination of data of one or more types, associated with one or more sensors or one or more sensor types, associated with one or more input modalities, associated with one or more parts of a user (e.g., eyes, nose, cheeks, mouth, hands, fingers, arms, torso, etc.) or the entire user, and/or associated with one or more items worn or held by the user (e.g., mobile devices, tablets, laptops, laser pointers, hand-held controllers, wands, rings, watches, bracelets, necklaces, etc.). In some implementations, the user activity data may include instructions received via an input device (e.g., typing a request via a keyboard vs spoken instruction).

In some implementations, the method 1000 further includes identifying the interaction event data for the application and may involve identifying only certain types of activity within the user activity to be included in the interaction event data. In some implementations, activity (e.g., types of activity) of the user activity that is determined to correspond to unintentional events rather than intentional user interface element input is excluded from the interaction event data. In some implementations, passive gaze-only activity of the user activity is excluded from the interaction event data. Such passive gaze-only behavior (not intentional input) is distinguished from intentional gaze-only interactions (e.g., gaze dwell, or performing a gaze up to the sky gesture to invoke/dismiss the gaze HUD, etc.).

Identifying the interaction event data for the application may involve identifying only certain attributes of the data corresponding to the user activity for inclusion in the interaction event data, e.g., including a hand center rather than the positions of all joints used to model a hand, including a single gaze direction or a single HID pointing direction for a given interaction event. In another example, a start location of a gaze direction/HID pointing direction is changed or withheld, e.g., to obscure data indicative of how far the user is from the user interface or where the user is in the 3D environment. In some implementations, the data corresponding to the user activity includes hands data representing the positions of multiple joints of a hand and the interaction event data includes a single hand pose that is provided instead of the hands data.

In some implementations, the method 1000 is performed by an electronic device that is a head-mounted device (HMD) and/or the XR environment is a virtual reality environment or an augmented reality environment.

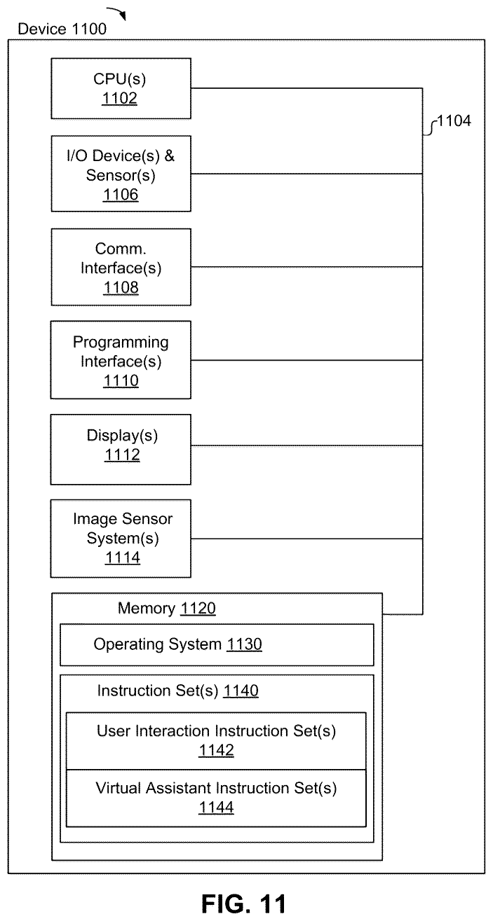

FIG. 11 is a block diagram of electronic device 1100. Device 1100 illustrates an exemplary device configuration for electronic device 110 or electronic device 105. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1100 includes one or more processing units 1102 (e.g., microprocessors, ASICs, FPGAs, GPUs, CPUs, processing cores, and/or the like), one or more input/output (I/O) devices and sensors 1106, one or more communication interfaces 1108 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 1110, one or more output device(s) 1112, one or more interior and/or exterior facing image sensor systems 1114, a memory 1120, and one or more communication buses 1104 for interconnecting these and various other components.

In some implementations, the one or more communication buses 1104 include circuitry that interconnects and controls communications between system components. In some implementations, the one or more I/O devices and sensors 1106 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 1112 include one or more displays configured to present a view of a 3D environment to the user. In some implementations, the one or more output device(s) 1112 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 1100 includes a single display. In another example, the device 1100 includes a display for each eye of the user.

In some implementations, the one or more output device(s) 1112 include one or more audio producing devices. In some implementations, the one or more output device(s) 1112 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 1112 may additionally or alternatively be configured to generate haptics.

In some implementations, the one or more image sensor systems 1114 are configured to obtain image data that corresponds to at least a portion of a physical environment. For example, the one or more image sensor systems 1114 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 1114 further include illumination sources that emit light, such as a flash. In various implementations, the one or more image sensor systems 1114 further include an on-camera image signal processor (ISP) configured to execute a plurality of processing operations on the image data.

The memory 1120 includes high-speed random-access memory, such as DRAM, SRAM, DDR RAM, or other random-access solid-state memory devices. In some implementations, the memory 1120 includes non-volatile memory, such as one or more magnetic disk storage devices, optical disk storage devices, flash memory devices, or other non-volatile solid-state storage devices. The memory 1120 optionally includes one or more storage devices remotely located from the one or more processing units 1102. The memory 1120 includes a non-transitory computer readable storage medium.

In some implementations, the memory 1120 or the non-transitory computer readable storage medium of the memory 1120 stores an optional operating system 1130 and one or more instruction set(s) 1140. The operating system 1130 includes procedures for handling various basic system services and for performing hardware dependent tasks. In some implementations, the instruction set(s) 1140 include executable software defined by binary information stored in the form of electrical charge. In some implementations, the instruction set(s) 1140 are software that is executable by the one or more processing units 1102 to carry out one or more of the techniques described herein.

The instruction set(s) 1140 include user interaction instruction set(s) 1142 configured to, upon execution, identify and/or interpret user gestures and other user activities as described herein. The instruction set(s) 1140 further include virtual assistant instruction set(s) 1144 configured to, upon execution, control the interactions with an intelligent virtual assistant, as described herein. In some implementations, each of the applications is provided for as a separately-executing set of code, e.g., capable of being executed via an application process. The instruction set(s) 1140 may be embodied as a single software executable or multiple software executables.

Although the instruction set(s) 1140 are shown as residing on a single device, it should be understood that in other implementations, any combination of the elements may be located in separate computing devices. Moreover, the figure is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

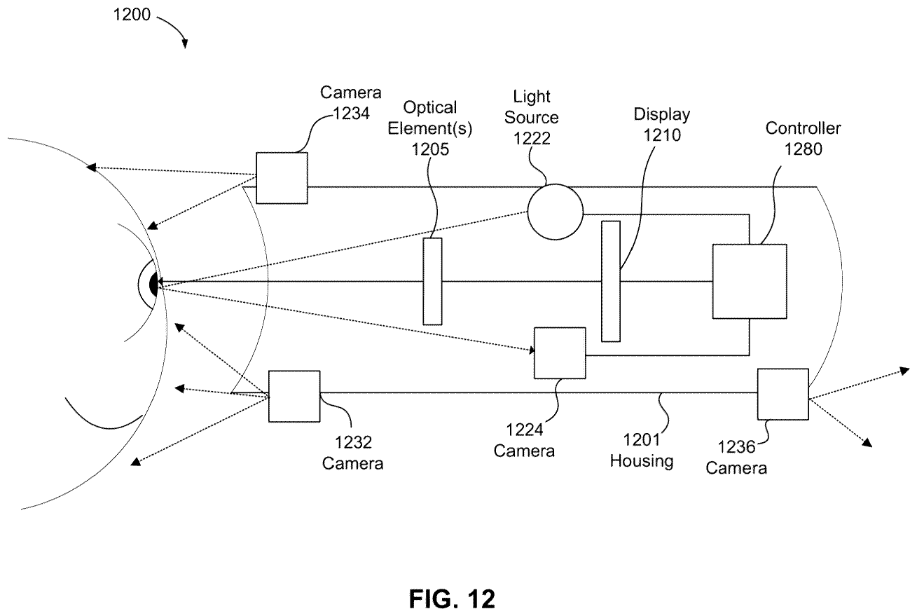

FIG. 12 illustrates a block diagram of an exemplary head-mounted device 1200 in accordance with some implementations. The head-mounted device 1200 includes a housing 1201 (or enclosure) that houses various components of the head-mounted device 1200. The housing 1201 includes (or is coupled to) an eye pad (not shown) disposed at a proximal (to the user 102) end of the housing 1201. In various implementations, the eye pad is a plastic or rubber piece that comfortably and snugly keeps the head-mounted device 1200 in the proper position on the face of the user 102 (e.g., surrounding the eye of the user 102).

The housing 1201 houses a display 1210 that displays an image, emitting light towards or onto the eye of a user 102. In various implementations, the display 1210 emits the light through an eyepiece having one or more optical elements 1205 that refracts the light emitted by the display 1210, making the display appear to the user 102 to be at a virtual distance farther than the actual distance from the eye to the display 1210. For example, optical element(s) 1205 may include one or more lenses, a waveguide, other diffraction optical elements (DOE), and the like. For the user 102 to be able to focus on the display 1210, in various implementations, the virtual distance is at least greater than a minimum focal distance of the eye (e.g., 7 cm). Further, in order to provide a better user experience, in various implementations, the virtual distance is greater than 1 meter.

The housing 1201 also houses a tracking system including one or more light sources 1222, camera 1224, camera 1232, camera 1234, camera 1236, and a controller 1280. The one or more light sources 1222 emit light onto the eye of the user 102 that reflects as a light pattern (e.g., a circle of glints) that may be detected by the camera 1224. Based on the light pattern, the controller 1280 may determine an eye tracking characteristic of the user 102. For example, the controller 1280 may determine a gaze direction and/or a blinking state (eyes open or eyes closed) of the user 102. As another example, the controller 1280 may determine a pupil center, a pupil size, or a point of regard. Thus, in various implementations, the light is emitted by the one or more light sources 1222, reflects off the eye of the user 102, and is detected by the camera 1224. In various implementations, the light from the eye of the user 102 is reflected off a hot mirror or passed through an eyepiece before reaching the camera 1224.

The display 1210 emits light in a first wavelength range and the one or more light sources 1222 emit light in a second wavelength range. Similarly, the camera 1224 detects light in the second wavelength range. In various implementations, the first wavelength range is a visible wavelength range (e.g., a wavelength range within the visible spectrum of approximately 400-700 nm) and the second wavelength range is a near-infrared wavelength range (e.g., a wavelength range within the near-infrared spectrum of approximately 700-1400 nm).

In various implementations, eye tracking (or, in particular, a determined gaze direction) is used to enable user interaction (e.g., the user 102 selects an option on the display 1210 by looking at it), provide foveated rendering (e.g., present a higher resolution in an area of the display 1210 the user 102 is looking at and a lower resolution elsewhere on the display 1210), or correct distortions (e.g., for images to be provided on the display 1210).

In various implementations, the one or more light sources 1222 emit light towards the eye of the user 102 which reflects in the form of a plurality of glints.

In various implementations, the camera 1224 is a frame/shutter-based camera that, at a particular point in time or multiple points in time at a frame rate, generates an image of the eye of the user 102. Each image includes a matrix of pixel values corresponding to pixels of the image which correspond to locations of a matrix of light sensors of the camera. In implementations, each image is used to measure or track pupil dilation by measuring a change of the pixel intensities associated with one or both of a user's pupils.

In various implementations, the camera 1224 is an event camera including a plurality of light sensors (e.g., a matrix of light sensors) at a plurality of respective locations that, in response to a particular light sensor detecting a change in intensity of light, generates an event message indicating a particular location of the particular light sensor.

In various implementations, the camera 1232, camera 1234, and camera 1236 are frame/shutter-based cameras that, at a particular point in time or multiple points in time at a frame rate, may generate an image of the face of the user 102 or capture an external physical environment. For example, camera 1232 captures images of the user's face below the eyes, camera 1234 captures images of the user's face above the eyes, and camera 1236 captures the external environment of the user (e.g., environment 100 of FIG. 1). The images captured by camera 1232, camera 1234, and camera 1236 may include light intensity images (e.g., RGB) and/or depth image data (e.g., Time-of-Flight, infrared, etc.).

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at an electronic device having a processor, a display, and one or more sensors:
presenting a view of a three-dimensional (3D) environment, wherein a virtual assistant is positioned at a 3D position based on a 3D coordinate system associated with the 3D environment;
receiving data corresponding to a first user activity in the 3D coordinate system for a first period of time;
identifying a user interaction event associated with the virtual assistant in the 3D environment based on the data corresponding to the user activity;
providing a graphical indication corresponding to one or more attributes associated with the virtual assistant based on identifying the user interaction event; and
in accordance with receiving data corresponding to a second user activity for a second period of time, generating one or more user interface elements that are positioned at 3D positions based on the 3D coordinate system associated with the 3D environment.

2. The method of claim 1, wherein the one or more user interface elements are customized based on a large language model (LLM) associated with the virtual assistant.

3. The method of claim 1, wherein the one or more attributes associated with the virtual assistant are based on adjustable settings that comprises at least one of:
a type of large language model (LLM);
a type of personality;
a response style;
a temperature style; and
a pedagogical approach selection.

4. The method of claim 1, wherein generating the one or more user interface elements comprises determining one or more candidate representations based on a determined context of one or more utterances.

5. The method of claim 4, wherein the one or more candidate representations are updated based on data corresponding to user activity for a second period of time.

6. The method of claim 4, wherein the one or more candidate representations comprises at least one of:
a candidate text representation;
a candidate audio representation;
a candidate image representation;
a candidate video representation; and
a candidate virtual object representation.

7. The method of claim 6, wherein the candidate virtual object representation comprises a 3D interactive model.

8. The method of claim 6, further comprising:
providing a stream of spatialized audio at a 3D position within the 3D coordinate system associated with the 3D environment, wherein the 3D position of the stream of spatialized audio corresponds to the 3D position of the virtual assistant.

9. The method of claim 8, wherein utterances associated with the stream of spatialized audio are correlated to utterances associated with the candidate text representation.

10. The method of claim 8, wherein utterances associated with the stream of spatialized audio are different than the candidate text representation.

11. The method of claim 1, wherein the graphical indication is a virtual effect corresponding to an eye or pair of eyes associated with the virtual assistant.

12. The method of claim 1, further comprising:
determining a context of a user based on at least one of the first user activity, the second user activity, and one or more physiological cues of the user; and
updating the graphical indication of the virtual assistant is based on the determined context.

13. The method of claim 1, wherein the data corresponding to the first user activity or the data corresponding to the second user activity is obtained via the one or more sensors on the device.

14. The method of claim 1, wherein the data corresponding to the first user activity or the data corresponding to the second user activity comprises gaze data comprising a stream of gaze vectors corresponding to gaze directions over time during use of the electronic device.

15. The method of claim 1, wherein the data corresponding to the first user activity or the data corresponding to the second user activity comprises an audio stream that includes one or more utterances or instructions received via an input device.

16. The method of claim 1, wherein the data corresponding to the first user activity or the data corresponding to the second user activity comprises hands data that includes a hand pose skeleton of multiple joints for each of multiple instants in time during use of the electronic device.

17. The method of claim 1, wherein the data corresponding to the first user activity or the data corresponding to the second user activity comprises at least one of hands data, controller data, gaze data, and head movement data.

18. The method of claim 1, wherein the electronic device comprises a head-mounted device (HMD).

19. A device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations comprising:
presenting a view of a three-dimensional (3D) environment, wherein a virtual assistant is positioned at a 3D position based on a 3D coordinate system associated with the 3D environment;
receiving data corresponding to a first user activity in the 3D coordinate system for a first period of time;
identifying a user interaction event associated with the virtual assistant in the 3D environment based on the data corresponding to the user activity;
providing a graphical indication corresponding to one or more attributes associated with the virtual assistant based on identifying the user interaction event; and
in accordance with receiving data corresponding to a second user activity for a second period of time, generating one or more user interface elements that are positioned at 3D positions based on the 3D coordinate system associated with the 3D environment.

20. A non-transitory computer-readable storage medium, storing program instructions executable on a device to perform operations comprising:
presenting a view of a three-dimensional (3D) environment, wherein a virtual assistant is positioned at a 3D position based on a 3D coordinate system associated with the 3D environment;
receiving data corresponding to a first user activity in the 3D coordinate system for a first period of time;
identifying a user interaction event associated with the virtual assistant in the 3D environment based on the data corresponding to the user activity;
providing a graphical indication corresponding to one or more attributes associated with the virtual assistant based on identifying the user interaction event; and
in accordance with receiving data corresponding to a second user activity for a second period of time, generating one or more user interface elements that are positioned at 3D positions based on the 3D coordinate system associated with the 3D environment.
